(19) United States
(12) Patent Application Publication
(10) Pub. No.: US 2023/0013918 A1
(43) Pub. Date: Jan. 19, 2023

(54) METHODS AND SYSTEMS FOR USING SHIPPING CONTAINERS AS ARCHITECTURAL ELEMENTS OF A FACILITY HAVING NUMEROUS GREENHOUSES

(71) Applicant: Eric N. Merryman, Albuquerque, NM (US)

(72) Inventor: Eric N. Merryman, Albuquerque, NM (US)

(21) Appl. No.: 17/377,327

(22) Filed: Jul. 15, 2021

(51) Int. Cl. A01G 9/16; A01G 9/24

(52) U.S. Cl. CPC A01G 9/16; A01G 9/243; A01G 9/249

(57) ABSTRACT

A greenhouse facility can include greenhouses such as a first greenhouse and a second greenhouse. The greenhouse facility can also include work units such as a first work unit and a second work unit. The greenhouses and work units can be organized as tenant units that each include at least one greenhouse and at least one work unit. A common roof can cover all the greenhouses and work units. The common roof can include greenhouse canopies and work unit roofs. The greenhouses can be environmentally isolated from the outside environment and from the other greenhouses. The tenant units can be secured from entry via the other tenant units. The greenhouse facility can be formed with shipping containers as architectural elements such as the work units, controlled entry units, etc. The controlled entry units can be used for providing secured access to the greenhouses, work units, and tenant units.

### TECHNICAL FIELD

The embodiments relate to shipping containers, intermodal shipping containers, green houses, secured greenhouses, a facility hosting multiple greenhouses, and a facility hosting multiple secured greenhouses that are secured from entry via other secured greenhouses within the facility.

### BACKGROUND

Shipping containers are core elements of the shipping industry. The most common shipping containers are intermodal shipping containers (ISCs). ISCs are sized and built in accordance with international standards. Similarly, cargo ships, dockyard equipment (e.g., cranes), trucks, and other equipment are designed specifically for handling and transporting ISCs. Shipping containers have also been used as architectural elements for shopping centers, micro-breweries, and other enterprises. In addition, shipping containers have also been used for containerized living units, bomb shelters, and “bug out” shelters. The driving factors for such uses of shipping containers are that they appeal to a certain aesthetic, that they are abundantly and inexpensively available, that they are structurally sound, and that they are specifically designed for minimizing the costs of transporting the containers to where they are needed.

The International Organization of Standardization (ISO) has published the standard ISO 668 titled “Series 1 freight containers” that provides sizes for ISCs. The common name for one size of ISCs is “20 foot”. A 20 foot ISC is 20 feet long, 8 feet wide, and 8 feet tall. ISCs are sometimes referred to by their capacity in “Twenty foot Equivalent Units” (TEUs). A 20 foot ISC has one TEU. The common name for another size of ISCs is “40 foot”. A 40 foot ISC is 40 feet long, 8 feet wide, and 8 feet tall. A 40 foot ISC has two TEUs.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure as a prelude to the more detailed description that is presented later.

One aspect of the subject matter described in this disclosure can be implemented by a greenhouse facility. The greenhouse facility can include a plurality of greenhouses that includes a first greenhouse and a second greenhouse, a plurality of work units that includes a first work unit and a second work unit, a common roof, and a plurality of tenant units that each include at least one of the greenhouses and at least one of the work units, wherein the greenhouses are environmentally isolated from an outside environment, the first greenhouse is environmentally isolated from the second greenhouse, the tenant units are each secured from entry via another tenant unit, and the tenant units are positioned under the common roof.

Another aspect of the subject matter described in this disclosure can be implemented by a greenhouse facility. The greenhouse facility can include a plurality of greenhouses that includes a first greenhouse and a second greenhouse, a plurality of intermodal shipping containers configured as a plurality of architectural elements, and a plurality of work units that includes a first work unit and a second work unit, wherein the greenhouses are environmentally isolated from an outside environment, the first greenhouse is environmentally isolated from the second greenhouse, the architectural elements include the work units, and the work units and the greenhouses have a common roof.

Yet another aspect of the subject matter described in this disclosure can be implemented by a system. The system can include a means for using a plurality of intermodal shipping containers as a plurality of architectural elements of a greenhouse facility that includes a plurality of environmentally isolated greenhouses under a common roof.

In some implementations of the methods, systems, and facilities, the greenhouses are separated by at least one of the work units. In some implementations of the methods, systems, and facilities, the common roof includes a greenhouse canopy positioned over the first greenhouse. In some implementations of the methods, systems, and facilities, the greenhouses have greenhouse canopies, the work units have work unit roofs, and the common roof includes the greenhouse canopies and the work unit roofs. In some implementations of the methods, systems, and facilities, the greenhouse facility includes an outside perimeter wherein the greenhouses include a plurality of perimeter greenhouses, and at least one of the greenhouses is isolated from the outside perimeter by the perimeter greenhouses.

In some implementations of the methods, systems, and facilities, a plurality of intermodal shipping containers is configured as a plurality of architectural elements that include the work units. In some implementations of the methods, systems, and facilities, the architectural elements include perimeter units that form an outside perimeter of the greenhouse facility. In some implementations of the methods, systems, and facilities, the greenhouses are separated by at least one of the architectural elements. In some implementations of the methods, systems, and facilities, the greenhouse facility is configured to be transported using the intermodal shipping containers.

In some implementations of the methods, systems, and facilities, the intermodal shipping containers provide a plurality of greenhouse walls of the greenhouses. In some implementations of the methods, systems, and facilities, one of the intermodal shipping containers is positioned between the first greenhouse and the second greenhouse, the one of the intermodal shipping containers provides a first greenhouse wall of the first greenhouse, and the one of the intermodal shipping containers provides a second greenhouse wall of the second greenhouse. In some implementations of the methods, systems, and facilities, the greenhouses include a plurality of greenhouse canopies that are supported by the intermodal shipping containers.

In some implementations of the methods, systems, and facilities, the greenhouse facility includes a plurality of tenant units that each include at least one of the greenhouses and at least one of the work units, wherein the tenant units are each secured from entry via another tenant unit. In some implementations of the methods, systems, and facilities, the greenhouse facility includes a first horizontal layer that includes the first greenhouse and the first work unit, and a second horizontal layer that includes an upper layer greenhouse and the second work unit, wherein the second horizontal layer is over the first horizontal layer. In some implementations of the methods, systems, and facilities, the greenhouse facility includes a solar panel positioned over and attached to at least one of the work units. In some implementations of the methods, systems, and facilities, the greenhouse facility is configured to be transported using the intermodal shipping containers. In some implementations of the methods, systems, and facilities, the first greenhouse is configured with a blackout system and a grow light lighting system.

In some implementations of the methods, systems, and facilities, the architectural elements include a plurality of work units and a plurality of greenhouse walls of the environmentally isolated greenhouses.

These and other aspects will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments such exemplary embodiments can be implemented in various devices, systems, and methods.

### BRIEF DESCRIPTION OF THE DRAWINGS

FIG. 1 illustrates intermodal shipping containers arranged to form a secured multi tenant greenhouse facility according to some aspects.

FIG. 2 illustrates entry paths through controlled entry units according to some aspects.

FIG. 3 illustrates greenhouses and work units having a common roof according to some aspects.

FIG. 4 illustrates a tenant unit according to some aspects.

FIG. 5 illustrates greenhouses that are environmentally isolated from one another and from the outside environment by shipping containers according to some aspects.

FIG. 6 illustrates perimeter greenhouses and an outside perimeter according to some aspects.

FIG. 7 illustrates intermodal shipping containers configured as architectural elements according to some aspects.

FIG. 8 illustrates a multilayer greenhouse facility that has intermodal shipping containers configured as architectural elements of a vertical farm according to some aspects.

FIG. 9 illustrates a greenhouse facility that has a blackout system and a grow light lighting system according to some aspects.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

A greenhouse facility can use shipping containers as architectural elements. As such, the shipping containers can be arranged to form the perimeter of the greenhouse facility, to form the dividers between different greenhouses within the greenhouse facility, etc. The shipping containers can be used as work units such as: access ways through which greenhouse personnel can access a greenhouse; storage areas; and areas where personnel perform tasks. Shipping containers, ISCs in particular, have solid floors, walls, and ceilings. Shipping containers are designed to be stacked, to support loads on their roofs, to support loads on their floors, to resist entry via their walls, to be secured against entry, and to protect their contents from the outside environment. Shipping containers are designed to environmentally isolate their contents from the outside environment. As such, the contents of different shipping containers are environmentally isolated from one another.

Shipping containers have roofs and, as such, the work units have roofs. The shipping containers can also be configured as structural supports for greenhouse canopies that cover the greenhouses. The work units and the greenhouses may therefore have a common roof that includes the work unit roofs and the greenhouse canopies. The common roof differentiates the greenhouse facility from a collection of isolated greenhouses. A greenhouse facility can be preferable to a collection of isolated greenhouses because the greenhouses in a facility can share resources (e.g., HVAC, power, water, etc.), can be more easily secured, can be more easily environmentally isolated from the outside, and may have lower construction costs.

A greenhouse facility can have multiple tenants. As such, the facility can be configured with numerous tenant units. Each tenant unit can include at least one work unit and at least one greenhouse. As such, each tenant can have a work space and a growing space. For purposes of competition or government regulation, the tenant units can be secured from entry via other tenant units or the outside. Some crops are highly regulated by local, state, and federal government regulations. Aspects of those regulations can require growing the regulated crop in a secured greenhouse. A secured greenhouse is secured from entry by anyone except authorized personnel. In some jurisdictions, a secured greenhouse must be certified as secure before the regulated crop can be legally grown in the greenhouse. A greenhouse facility that uses shipping containers as architectural elements can benefit from the secure properties of the shipping containers. As discussed above, the shipping containers, by design, provide security. As such, the greenhouse facility can be a secured greenhouse facility that includes numerous secured greenhouses. The operator of the secured greenhouse facility can work with certification authorities to obtain certifications that the secured greenhouses are secure. The tenants are thereby relieved of the need to certify the secured greenhouses before growing their crops. This provides a significant commercial advantage to the tenants because certification can take months or years. Furthermore, a limited number of certifications within a jurisdiction may, in effect, lock innovative tenants from trying new experimental crops. Pre-certified secured greenhouses provide an avenue for those tenants to thrive.

The shipping containers can provide environmental isolation between the greenhouses. Different crops that are grown in different greenhouses may be kept at different temperatures and at different humidities. Furthermore, different crops may prefer different lighting. The temperature, humidity, and lighting provided to a crop can vary based on the crop, the crop's life cycle, experimental parameters, etc. For example, young plants may have periods of darkness while older plants may have no dark period at all such that the crop grows and leafs out to a maximal extent. Another concern is that different strains of a crop may be grown in different greenhouses within the facility. In such situations, environmental isolation can prevent cross contamination, pollination, or other inter-crop interactions that may be disastrous for a crop, especially an experimental new crop. Yet another concern is pests and plant disease. Environmental isolation can prevent pests and plant diseases from spreading from one greenhouse to another. Preventing the spread of pests and diseases has the additional benefit of reducing or eliminating the use of insecticides and other treatments that may impact the quality or marketability of a crop. Greenhouses can be considered to be environmentally isolated when they can be maintained with different environmental conditions such as different temperature, different humidity, different lighting, etc. Greenhouses can be considered to be environmentally isolated when the greenhouses are configured to prevent pathogens, pollen, etc. from spreading from one greenhouse to another. A greenhouse can be considered to be environmentally isolated from the outside environment when it can be maintained at, relative to the outside environment, different environmental conditions such as different temperature, different humidity, different lighting, etc. A greenhouse can be considered to be environmentally isolated from the outside environment when the greenhouse is configured to prevent pathogens, pollen, etc. from spreading from the outside into the greenhouse. It is understood that greenhouse personnel can defeat environmental isolation though failure to follow protocols such as washing hands, changing footwear, etc. when entering a greenhouse.

Another consideration is that shipping containers are designed for shipping. As such, modified shipping containers can be shipped very cost effectively because the modified container unit is substantially its own packaging. The shipping containers that are used as architectural elements, work units, etc. of a greenhouse facility can be modified at a customization facility. The customization facility can customize the shipping containers and prepare them for shipping. After reaching the greenhouse facility location, the shipping containers can be positioned in accordance with the facility's design. The greenhouse facility may be substantially complete once the shipping containers are set in their proper positions and the greenhouse canopies are installed. Furthermore, a set of commonly used architectural elements (e.g., ISCs configured as work units with doorways and/or security doors) can be kept in stock at the customization facility such that a greenhouse facility can be shipped to a customer site as soon as an order or payment is received.

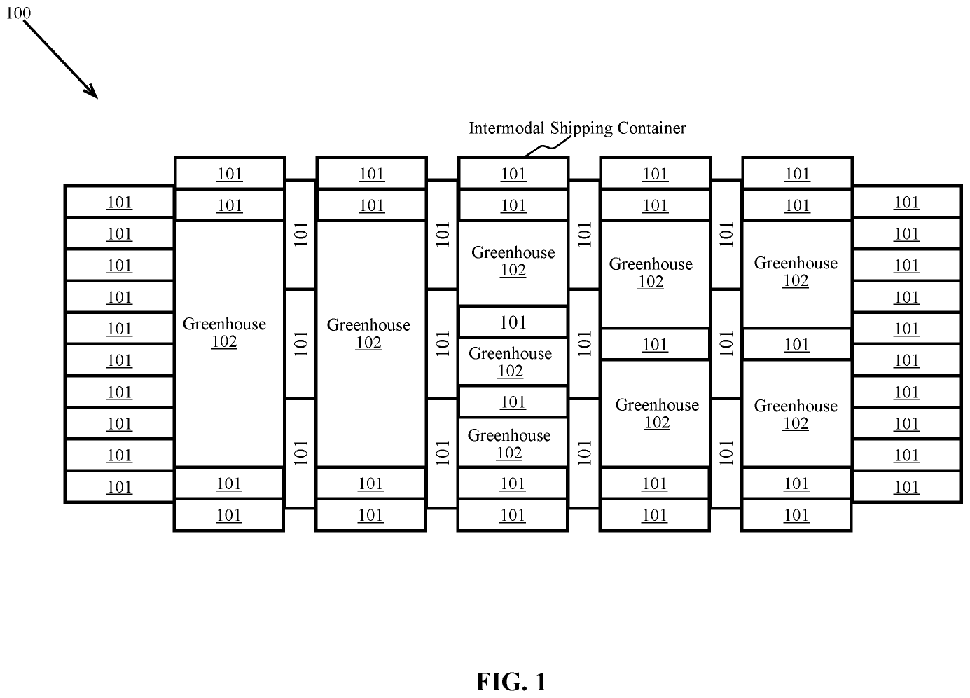

FIG. 1 illustrates intermodal shipping containers 101 arranged to form a secured multi tenant greenhouse facility 100 according to some aspects. The shipping containers 101 are positioned as the outside walls of the facility and as the dividers between the green houses 102. Although the figures are not to scale, the shipping containers are observed to all be the same size ISC. Other examples may use combinations of differently sized ISCs. The most common ISCs are 8 feet wide, 8 feet high, and either 20 feet long or 40 feet long. As such, an approximately 40-foot length of outside perimeter or intra-facility divider can be formed from two 20-foot ISCs or one 40-foot ISC. The ISCs may be used as work units that are accessible through adjacent greenhouses. As can be seen, some tenant units may have a great number of work units (e.g., the leftmost greenhouse in FIG. 1) while others do not.

The greenhouse facility illustrated in FIG. 1 shows square or rectangular greenhouses that have greenhouse walls. The shipping containers are shown forming all of the greenhouse walls of the greenhouses. Greenhouse walls can be formed from the sidewalls of shipping containers, such as the 40 foot long walls of 40 foot long ISCs. Greenhouse walls can be formed from the short walls of shipping containers, such as the 8 foot wide walls on the ends of ISCs. Greenhouse walls can be formed from a combination of sidewalls and short walls of ISCs. A greenhouse wall may include a section that is not part of a shipping container. A shipping container can be positioned between a first greenhouse and a second greenhouse, thereby providing environmental isolation between the greenhouses. As such, a greenhouse wall of the first greenhouse is provided by one wall of the shipping container and a greenhouse wall of the second greenhouse is provided by another wall of the shipping container. A single greenhouse wall may be provided by more than one shipping container.

The greenhouses 102 of FIG. 1 are shown having a greenhouse width that is the length of one shipping container. For example, the shipping containers can be 40 foot long ISCs. In such a case, the greenhouses 102 of FIG. 1 would all be 40 feet wide and have two 40 foot long walls provided by two 40 foot ISCs. The greenhouses can have other widths. Greenhouse widths of 20 feet, 40 feet, 60 feet, 80 feet, etc. can be provided by combinations of 20 foot ISCs and 40 foot ISCs placed end-to-end. ISCs can be 8 feet wide. As such, even more greenhouse widths can be provided. For example, a 68 foot greenhouse wall can be provided by two 20 foot ISCs and one 40 foot ISC. Many other combinations of ISCs also provide 68 foot greenhouse walls.

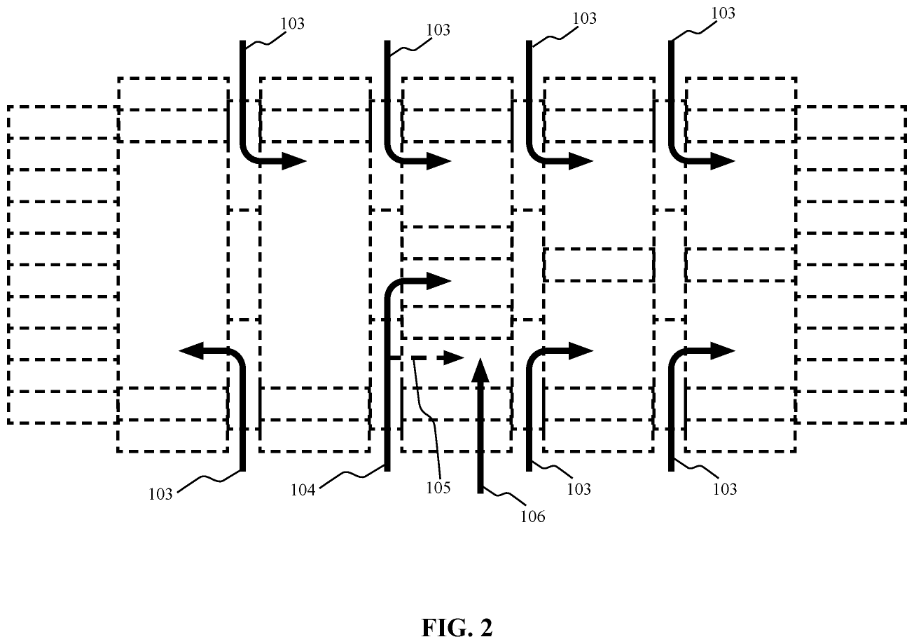

FIG. 2 illustrates entry paths through controlled entry units according to some aspects. The controlled entry units can be shipping containers that have security doors at the greenhouse facility perimeter such that personnel must unlock a security door in order to enter any of the controlled entry units. Personnel may proceed through the controlled entry unit to a greenhouse. Security doors are doors with a locking mechanism and can be keyed differently, have different access codes, etc. such that personnel having access to one controlled entry unit may not have access to other controlled entry units. As such, a tenant's greenhouse and work unit can be secured from entry by another tenant. The controlled entry units can be work units in which a tenant may store tools, keep records, and perform tasks. The greenhouse canopies can be supported by the controlled entry units.

Most of the illustrated entry paths are short wall entry paths 103. Short wall entry paths 103 pass through at least one of the ends of a shipping container. Long entry paths 104 are short wall entry paths that pass through at least two shipping containers. Sidewall entry paths 106 are entry paths that pass through two sidewalls of a shipping container. Shared entry paths 105 are entry paths that share a door on the outside perimeter of the greenhouse facility. Security doors may be placed at any of the locations at which an entry path passes into or out of a shipping container. As such, every tenant unit can be secured against entry via any other tenet unit. Security doors may be installed throughout the facility such that entry paths can be rerouted to accommodate tenants. For example, a tenant leasing numerous greenhouses may have a single security door into the greenhouse facility and no security doors inside the facility. Alternatively, a tenant can have security doors inside the facility to further restrict access to certain greenhouses or work units. For example, access to one greenhouse (e.g., one with an experimental crop) or one work unit (e.g., one with sensitive documents) may be restricted to a subset of personnel.

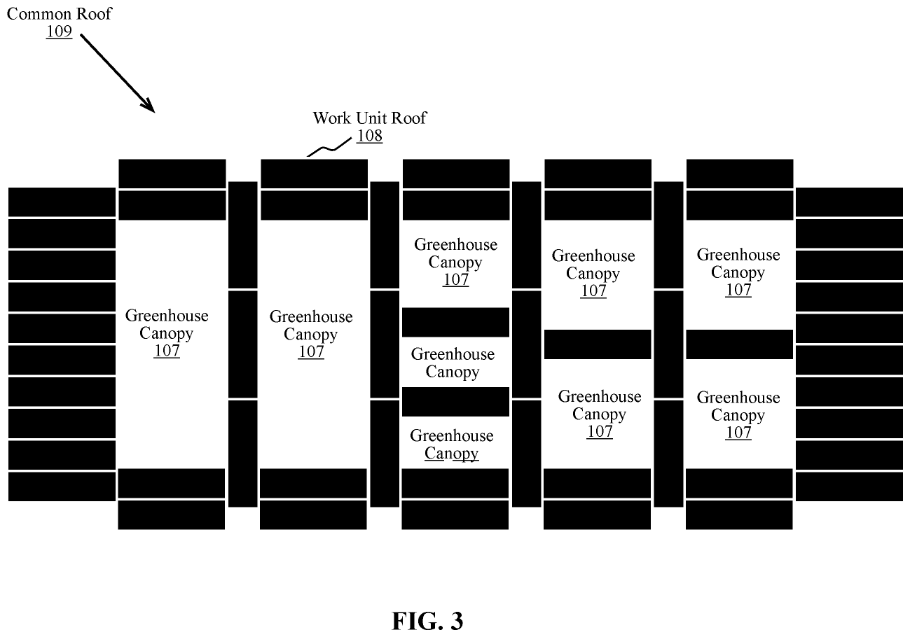

FIG. 3 illustrates greenhouses and work units having a common roof 109 according to some aspects. The work units have work unit roofs 108. For example, the roof of an ISC can be the work unit roof. Alternatively, roofing structures may be attached to the greenhouse facility over some or all of the ISCs to improve insulation, collect solar energy, collect water, etc. Greenhouse canopies 107 can be installed over the greenhouses. For example, trusses spanning a greenhouse may be attached to the ISCs and a cover material may be arranged over and on the trusses to thereby form a greenhouse canopy. As discussed above, the shipping containers may be modified at a container customization facility and prepared for shipping. The greenhouse trusses and the cover material may be shipped within the customized shipping containers.

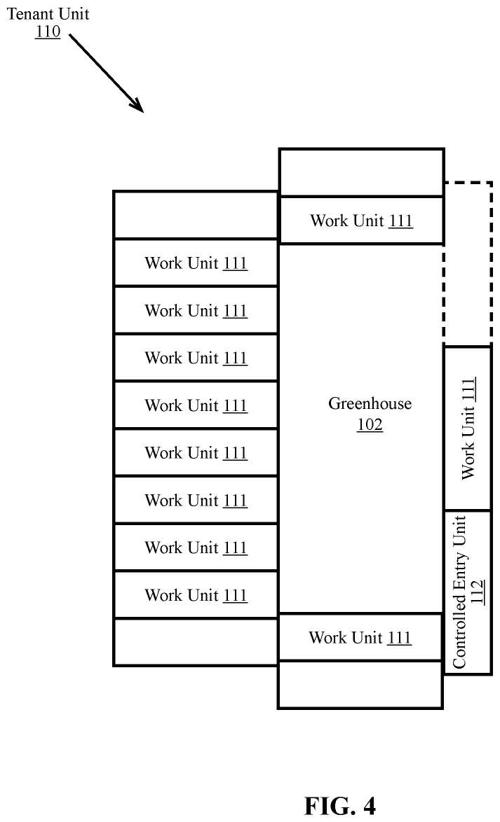

FIG. 4 illustrates a tenant unit 110 according to some aspects. The tenant unit 110 illustrated in FIG. 4 is the leftmost work unit in FIGS. 1-3. A tenant unit has at least one work unit 111 and at least one greenhouse 102. The illustrated tenant unit 110 has eleven work units 111 and one greenhouse. The controlled entry unit 112 may be a work unit as well. For example, the controlled entry unit may be configured for personnel to change into greenhouse garb such that their street clothes do not contaminate the greenhouse and vice versa. Open doorways, unsecured doors, or security doors can provide access between the work units 111, greenhouse 102, and controlled entry unit 112.

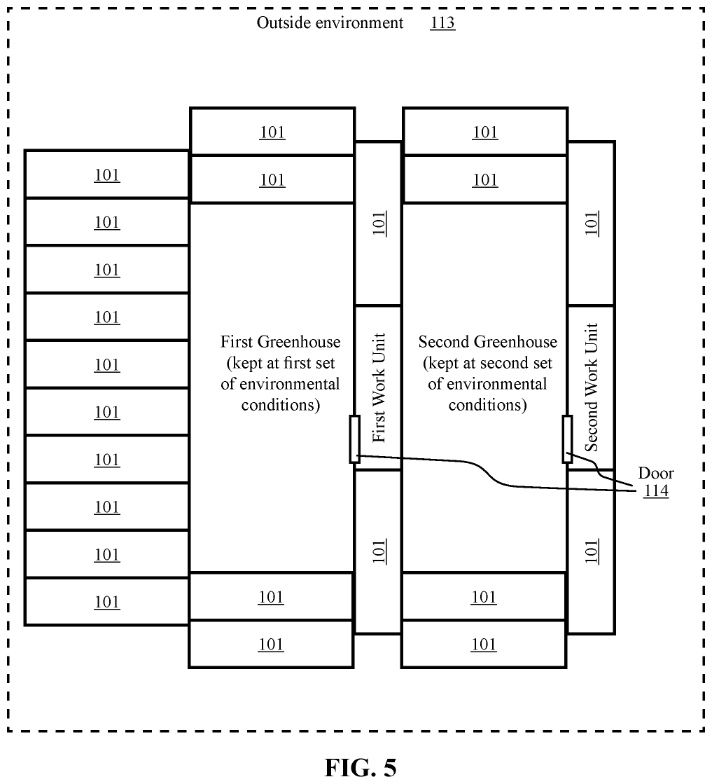

FIG. 5 illustrates greenhouses that are environmentally isolated from one another and from the outside environment by shipping containers according to some aspects. The outside perimeter of the greenhouse facility is formed by numerous ISCs 101. As discussed above, ISCs have standardized dimensions and the width dimension met by most ISCs is an eight foot width. As such, the sides of the greenhouses can be separated from the outside environment 113 by approximately eight feet of air, by insulating materials installed in the ISCs, etc. The tops of the greenhouses can be isolated from the outside environment 113 by the greenhouse canopies, by blackout systems, by solid roofs (e.g., a greenhouse may have a solid roof and artificial light). The environmental conditions inside greenhouses may therefore be very different from the environmental conditions inside the greenhouses.

A first greenhouse can be kept at a first set of environmental conditions while a second greenhouse is kept at a second set of environmental conditions. The greenhouses are environmentally isolated from one another by the ISCs, which are eight feet wide and thereby act as effective barriers to the transmission of heat, humidity, light, and contaminants between the greenhouses. A first tenant unit can include the first greenhouse and the first work unit. A second tenant unit can include the second greenhouse and the second work unit. Doors 114 provide for personnel to move between greenhouse and work unit within a tenant unit. The doors can be unsecured doors (e.g., doors that do not lock) or can be security doors (e.g., doors with keyed locking mechanisms, electronic/coded locking mechanisms, remotely actuated locking mechanisms, etc.).

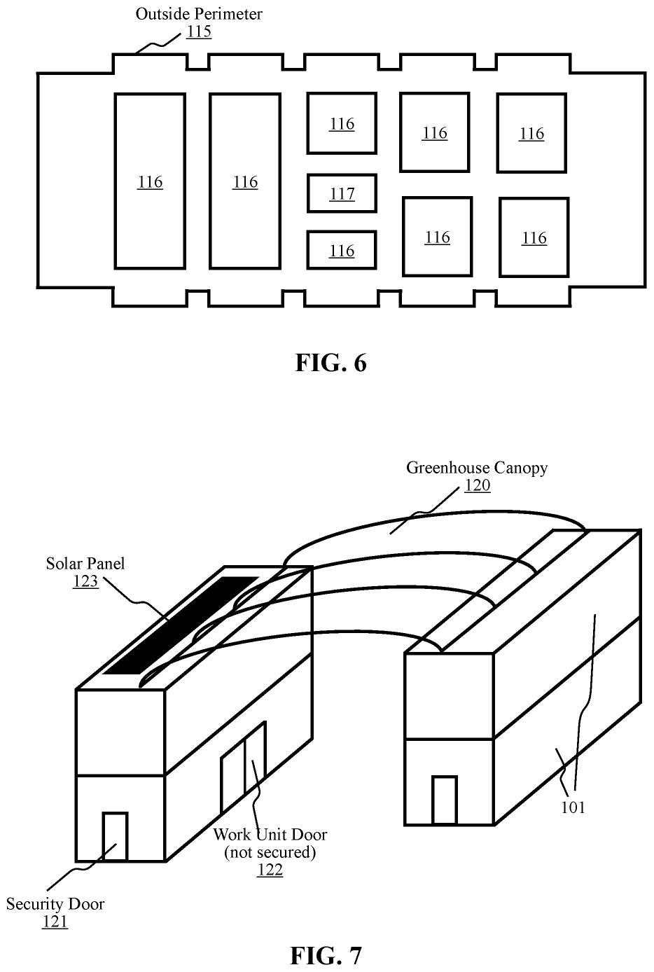

FIG. 6 illustrates perimeter greenhouses 116 and an outside perimeter 115 according to some aspects. The outside perimeter 115 can be formed by the outer walls of the outermost shipping containers. An interior greenhouse 117 is a greenhouse that has another greenhouse between each of its walls and the outside perimeter 115. A perimeter greenhouse 116 is a greenhouse that is not an interior greenhouse 117. Interior greenhouses 117 may be more secure than perimeter greenhouses 116 are. Interior greenhouses 117 may also be more environmentally isolated from the outside environment than perimeter greenhouses 116 are.

FIG. 7 illustrates intermodal shipping containers 101 configured as architectural elements according to some aspects. Here, the ISCs 101 are stacked two deep with a first horizontal layer and a second horizontal layer. The ISCs of the second horizontal layer are stacked on ISCs of the first horizontal layer. The greenhouse canopy 120 can be attached to the roofs of ISCs in the second horizontal layer. A solar panel 123 is attached to the roof of an ISC. Some greenhouses require little electrical power and may be solar powered. Crops grown in such greenhouses may be certified as environmentally friendly and thereby command a higher price. Some greenhouses consume copious amounts of electricity (e.g., greenhouses that use artificial light to ensure the crop is growing every hour of every day). Solar panels on the greenhouse facility can help offset the carbon footprint of greenhouses that consume large amounts of electricity. A security door 121 provides access into one of the work units. A work unit door 122 provides access between the work unit and the greenhouse.

Those practiced in greenhouse design are familiar with different types of canopies such as curved greenhouse canopies, single peaked greenhouse canopies, and dual peaked greenhouse canopies. The greenhouse of FIG. 7 is illustrated with a curved greenhouse canopy. Curved greenhouse canopies can be formed using a rolled sheet that is unrolled and fastened to the greenhouse trusses. Curved greenhouse canopies can be the least expensive type of canopy. Single and double peaked greenhouse canopies can be formed by attaching rigid glazing panels to the greenhouse trusses. Double peaked greenhouse canopies often have higher performance ratings than single peaked greenhouse canopies. Double peaked greenhouse canopies can also be more expensive than single peaked greenhouse canopies due to, for example, the need for an internal gutter.

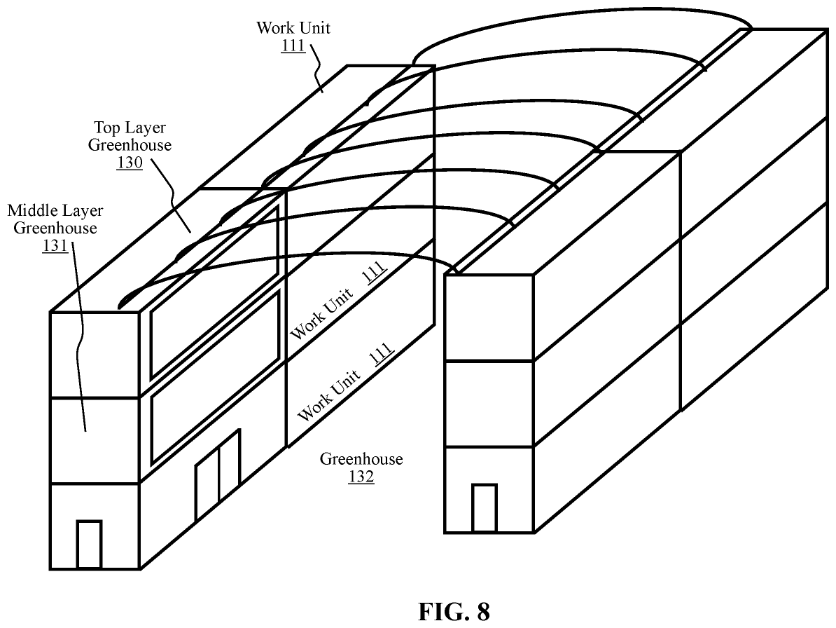

FIG. 8 illustrates a multilayer greenhouse facility that has intermodal shipping containers configured as architectural elements of a vertical farm according to some aspects. The greenhouse facility of FIG. 8 has three horizontal layers: a first horizontal layer at ground level; a second horizontal layer over the first horizontal layer; and a third horizontal layer over the second horizontal layer. A first greenhouse 132 in the first horizontal layer is located between the stacks of shipping containers. The first horizontal layer is at the ground level and includes the first greenhouse 132 and a work unit 111. Two of the shipping containers are configured as upper layer greenhouses 130, 131. One of the upper layer greenhouses is a middle layer greenhouse 131 that is in the second horizontal layer. The second horizontal layer also includes a work unit 111. Another one of the upper layer greenhouses is a top layer greenhouse 130 that is in the third horizontal layer. The third horizontal layer also includes a work unit 111. A greenhouse canopy can be supported by the ISCs of the third horizontal layer.

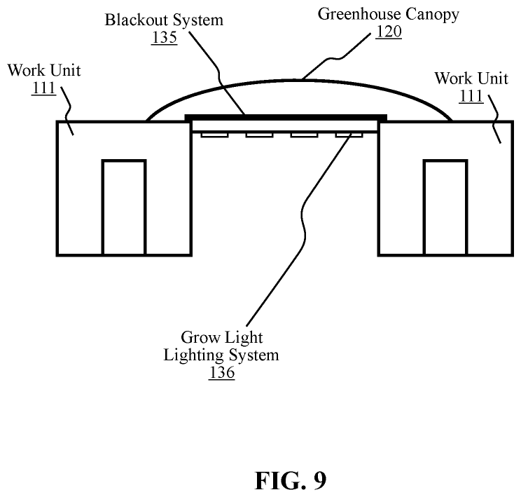

FIG. 9 illustrates a greenhouse facility that has a blackout system 135 and a grow light lighting system 136 according to some aspects. A grow light lighting system 136 can illuminate a crop when natural light is unavailable or insufficient. For example, plants in the vegetative stage may carry out photosynthesis and accumulate resources that may be used in the flowering stage and reproductive stage. Crops in the vegetative stage may grow well when given 16 hours of light per day and some thrive when given 24 hours of light per day. A grow light lighting system 136 may be used in addition to, or instead of, natural light to control a crop's lighting periods and thereby govern the crop's photosynthesis and resource accumulation during the vegetative stage. Flowering crops can have a flowering stage after the vegetative stage. A crop may require a biological trigger to enter the flowering stage. For example, twelve hours of darkness can be the biological trigger for some crops to enter the flowering stage. It is well known that at some latitudes the night is less than twelve hours for many months each year. A blackout system 135 can prevent outside light from entering the greenhouse. A blackout system 135 may therefore be used to trigger flowering of certain crops. Blackout systems can use sheets of opaque material to block outside light from entering greenhouses. The intensity of outside light entering the greenhouse may also be controlled using a translucent material that allows only a portion of the outside light to enter the greenhouse.

The blackout system 135, the grow light lighting system 136, and the greenhouse canopy 120 can be supported by shipping containers such as architectural elements (e.g., work units 111) bordering the greenhouse. In this manner, a substantial portion of the support structures for the blackout system 135, the grow light lighting system 136, and the greenhouse canopy 120 are provided by the shipping containers. As such, the shipping containers reduce the need for building support structures specifically for the blackout system 135, the grow light lighting system 136, or the greenhouse canopy 120.

Although the operations of the method(s) herein are shown and described in a particular order, the order of the operations may be altered so that certain operations may be performed in an inverse order or so that certain operations may be performed, at least in part, concurrently with other operations. Instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A greenhouse facility comprising:
a plurality of greenhouses that includes a first greenhouse and a second greenhouse;
a plurality of work units that includes a first work unit and a second work unit;
a common roof; and
a plurality of tenant units that each include at least one of the greenhouses and at least one of the work units, wherein
the greenhouses are environmentally isolated from an outside environment,
the first greenhouse is environmentally isolated from the second greenhouse,
the tenant units are each secured from entry via another tenant unit, and
the tenant units are positioned under the common roof.

2. The greenhouse facility of claim 1, wherein the greenhouses are separated by at least one of the work units.

3. The greenhouse facility of claim 1, wherein the common roof includes a greenhouse canopy positioned over the first greenhouse.

4. The greenhouse facility of claim 1, wherein:
the greenhouses have greenhouse canopies;
the work units have work unit roofs; and
the common roof includes the greenhouse canopies and the work unit roofs.

5. The greenhouse facility of claim 1 further including:
an outside perimeter wherein:
the greenhouses include a plurality of perimeter greenhouses; and
at least one of the greenhouses is isolated from the outside perimeter by the perimeter greenhouses.

6. The greenhouse facility of claim 1 wherein a plurality of intermodal shipping containers is configured as a plurality of architectural elements that include the work units.

7. The greenhouse facility of claim 6 wherein the architectural elements include perimeter units that form an outside perimeter of the greenhouse facility.

8. The greenhouse facility of claim 7 wherein the greenhouses are separated by at least one of the architectural elements.

9. The greenhouse facility of claim 8 wherein the greenhouse facility is configured to be transported using the intermodal shipping containers.

10. A greenhouse facility comprising:
a plurality of greenhouses that includes a first greenhouse and a second greenhouse;
a plurality of intermodal shipping containers configured as a plurality of architectural elements; and
a plurality of work units that includes a first work unit and a second work unit, wherein
the greenhouses are environmentally isolated from an outside environment,
the first greenhouse is environmentally isolated from the second greenhouse,
the architectural elements include the work units, and
the work units and the greenhouses have a common roof.

11. The greenhouse facility of claim 10, wherein the intermodal shipping containers provide a plurality of greenhouse walls of the greenhouses.

12. The greenhouse facility of claim 10, wherein:
one of the intermodal shipping containers is positioned between the first greenhouse and the second greenhouse;
the one of the intermodal shipping containers provides a first greenhouse wall of the first greenhouse; and
the one of the intermodal shipping containers provides a second greenhouse wall of the second greenhouse.

13. The greenhouse facility of claim 10, wherein the greenhouses include a plurality of greenhouse canopies that are supported by the intermodal shipping containers.

14. The greenhouse facility of claim 10 further including
a plurality of tenant units that each include at least one of the greenhouses and at least one of the work units,
wherein the tenant units are each secured from entry via another tenant unit.

15. The greenhouse facility of claim 10 further including:
a first horizontal layer that includes the first greenhouse and the first work unit; and
a second horizontal layer that includes an upper layer greenhouse and the second work unit,
wherein the second horizontal layer is over the first horizontal layer.

16. The greenhouse facility of claim 10 further including a solar panel positioned over and attached to at least one of the work units.

17. The greenhouse facility of claim 10 wherein the greenhouse facility is configured to be transported using the intermodal shipping containers.

18. The greenhouse facility of claim 10 wherein the first greenhouse is configured with a blackout system and a grow light lighting system.

19. A system comprising:
a means for using a plurality of intermodal shipping containers as a plurality of architectural elements of a greenhouse facility that includes a plurality of environmentally isolated greenhouses under a common roof.

20. The system of claim 19, wherein the architectural elements include a plurality of work units and a plurality of greenhouse walls of the environmentally isolated greenhouses.
